(19) United States
(12) Patent Application Publication
(10) Pub. No.: US 2009/0125708 A1
(43) Pub. Date: May 14, 2009

(54) INTERNET APPLIANCE

(75) Inventors: James Woodring, Pewaukee, WI (US); Steven Frank, Oconomowoc, WI (US)

Correspondence Address: GODFREY & KAHN S.C., 780 NORTH WATER STREET, MILWAUKEE, WI, 53202, US

(73) Assignee: RELATION SYSTEMS, INC., Pewaukee, WI (US)

(21) Appl. No.: 11/937,613

(22) Filed: Nov. 9, 2007

(51) Int. Cl. G06F 15/177

(52) U.S. Cl. 713/1

(57) ABSTRACT

A system, method and apparatus dedicated to accessing certain aspects of the Internet. The system includes a hardware device having a display and firmware associated with the display. The firmware includes a web browser and an operating system, configured to automatically connect to a datacenter server using the web browser, and to receive a frameset template from the datacenter, the frameset including frames, wherein each frame includes a preset content locator, upon boot of the operating system. The data center server may have preconfigured framesets with assigned content locators, and be configured to transmit one or more of the framesets to the device. Each frame may include content from transmitted from a different internet server upon boot of the operating system.

### BACKGROUND

This invention relates to Internet appliances, and specifically, to Internet appliances that are simple and have convenient interfaces.

While there are many people who use a general purpose computer to access the Internet, there are a large number of people who find general purpose computers hard to use, and/or who are put off by the problems often presented by general purpose computers.

### SUMMARY OF THE INVENTION

This invention provides a system, method and apparatus dedicated to accessing certain aspects of the Internet. The system includes a hardware device having a display and firmware associated with the display. The firmware includes a web browser and an operating system, configured to automatically connect to one or more Internet servers and to automatically display content from the one or more servers upon boot of the operating system. The operating system may be configured to automatically connect to a data center server using the web browser and to receive a frameset template from the datacenter, the frameset including frames, wherein each frame includes a preset content locator, upon boot of the operating system. The data center server may have preconfigured framesets with assigned content locators, and be configured to transmit one or more of the framesets to the device. Each frame may include content from transmitted from a different internet server upon boot of the operating system. Preferably the hardware device includes an input, including a touch-sensitive screen. In one embodiment, the apparatus is self contained and configured to be hung on a wall. Preferably, the apparatus and operating system are configured solely to: (1) contact an internet server using the web browser and download a frameset template including automatically executed embedded internet links and (2) display the frameset and network-enabled content addressed by the links. In one embodiment, the browser is a firmware-based or hard-wired browser.

The concept is an Internet-connected appliance for residential or kiosk use which gets its content and configuration from a centralized server. A simple Internet-based web application would allow the content and layout depicted on the appliance to be customized to a user's specific preferences.

The solution provided by the invention has three components. The first is the appliance itself. This appliance is similar to a PC only in that it has an operating system, application software—a standard Internet browser, and a touch screen method for interacting with the device. In the embodiment provided by the invention, the hardware, operating system and application software, and interface devices are different in that there is no local storage, resulting in a simple, low maintenance, and substantially malware-proof device which is a distinguishing factor from prior products.

The second component is the user interface. The methods provided by the present invention for selecting a specific frame, designating content, selecting different pages, selecting “full screen mode”, and refreshing to the initial configuration and layout, are unique to the present invention.

Lastly, the Internet-based control panel, which allows for simple customization and management of the content which is displayed on the device (or devices—since multiple devices can be managed as a single unit—see kiosk mode), is the result of custom application software which, similarly to the user interface, is germane to our product. While other “control panel” methods exist—it is our user environment (look & feel) and how it controls the device, which establishes our brand and makes our solution unique.

In summary, it is the combination of all three of these components which yields a unique and distinguishable solution.

This device is poised to benefit from the convergence of many Internet and home automation technologies. Sophisticated residential automation systems (Control4) currently exist which control HVAC, lighting, appliances, and home security. At the same time, there is a large push by the entertainment industry to allow for video and audio on demand or in a time shifted mode. Lastly, households are becoming better connected to the Internet (via high speed connections), have multiple computers, and have an increasing appetite for local information and convenience features.

All of these trends are supported by our product. Most of the technologies are currently Internet based or could be easily adapted to an Internet platform. What has been missing thus far is a simple, inexpensive, easily managed platform which unites those streams of data. Since the device is not a computer (in the general sense), the cost of ownership is minimal. There are no firewall/security/antivirus updates, no software patches (for which the user must take responsibility), no data backups or archival duties, and most importantly, no obsolescence since the device is merely the display (similar to a television) for the information.

Additional features include upgrades (improved screen size/resolution) and the addition of features (maybe an integrated video camera).

Standard logoed “SoftKeys” would be available via the Control Panel which would link to sites like Amazon, Weather Bug, Yahoo, Ebay, and any other partners.

### BRIEF DESCRIPTION OF THE DRAWINGS

FIG. 1 is a schematic illustration of an internet appliance system according to a preferred embodiment of the invention.

FIG. 2 is a pictorial view of the internet appliance system shown in FIG. 1.

FIG. 3 is screen shot showing an example of a user interface according to the invention.

FIG. 4 is a flow diagram describing the startup procedure according to the invention.

FIG. 5 is a screen shot showing an example of a “standard 4-square” frameset with various content displayed in the frames, according to the invention.

### DETAILED DESCRIPTION

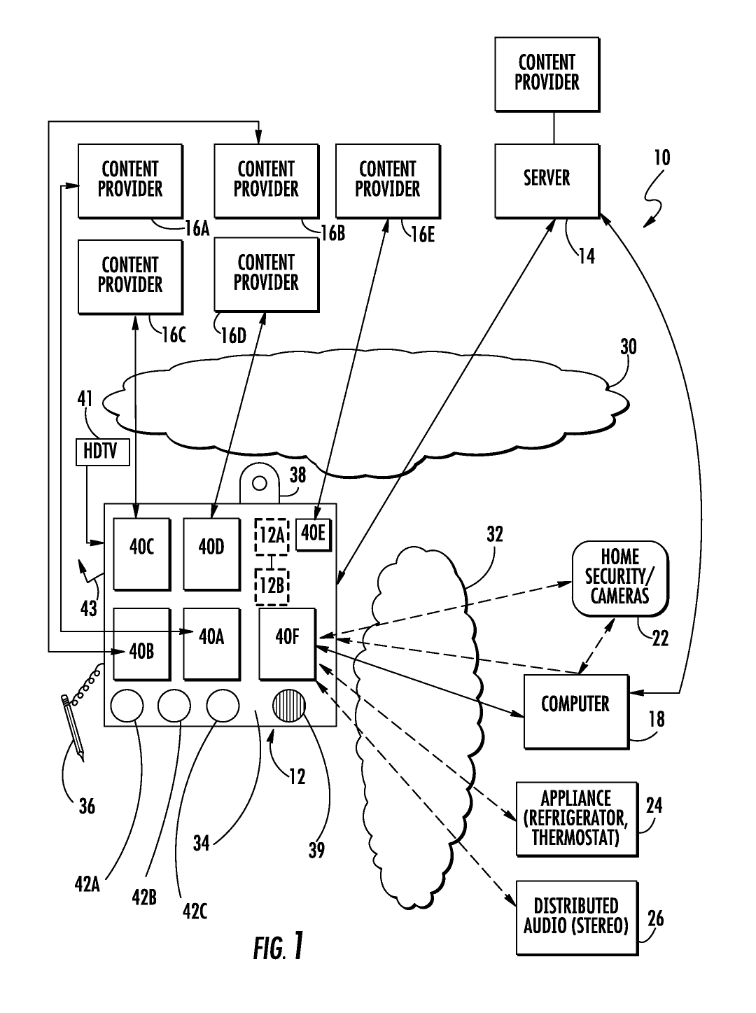

In FIG. 1 is shown an embodiment of an Internet appliance system 10 constructed according to a preferred embodiment of the invention. The overall system 10 includes an appliance 12, a system server 14, one or more network-enabled content providers, such as Internet content providers 16A, 16B, 16C, 16D and 16E, and intranet content providers 18, 22, 24 and 26. “Network-enabled content” is intended to include but not be limited to Internet content, Web applications, and any other suitable information available over a network, such as security information, sensor information, or entertainment-related audio/video information.

Appliance 12 comprises a device generally for use in a home or other space. Appliance 12 is a hardware device which includes a processor 12A, a volatile memory 12B, an operating system, such as Linux or preferably Windows or any other suitable operating system, a web browser such as Mozilla or preferably Internet Explorer or any other suitable browser, and a connection to the Internet or World Wide Web 30, and possibly also to a local intranet or internal local area network 32. Appliance 12 has a touch screen 34 and, in one embodiment, a stylus 36. In one embodiment, apparatus 12 may additionally include a video camera 38, such as a webcam, and a speaker/microphone 39.

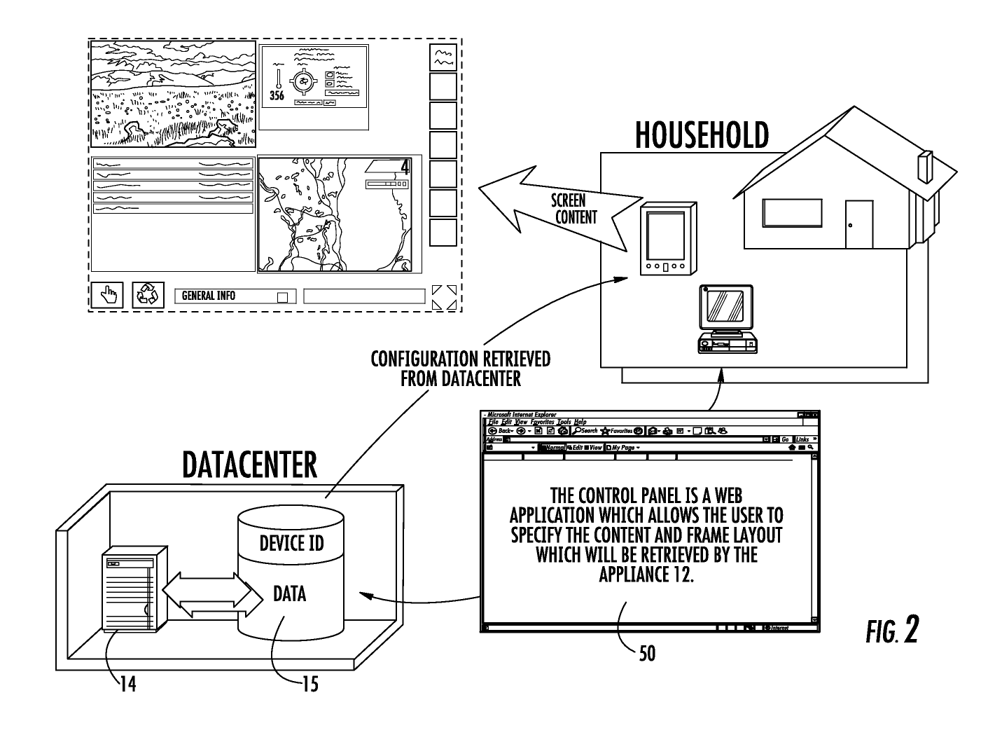

Server 14 includes a memory 15 (FIG. 2) for storing various display configurations for appliance 12. Such appliance configurations are created or configured by a human operator such as by operating a computer 18 (FIG. 1), which can be done via Internet 30. During such configuration, the human operator, using a keyboard and mouse or other input device associated with computer 18, identifies a serial number, and may see or otherwise recognize and associate it with appliance 12, so as to register appliance 12 with server 14. During such registration, the operator also identifies content providers 16 and one or more of intranet sources 18-26 from which the operator may later select. In one embodiment, the person may register for various subscription levels, each level providing additional functionality, or fewer ads for example, or no ads for another example, with a transmitted frame format.

Once configured on server 14, appliance 12 may be turned on. Once appliance 12 is turned on, the appliance begins to automatically contact server 14. Server 14 then transmits configuration information, specifically including a frame format or template in which digital content may be transmitted and displayed by the browser. In the example illustrated in FIG. 1, server 14 is transmitting a frame or template having six content windows 40A, 40B, 40C, 40D, 40E and 40F, and three customized settings touch points 42A, 42B and 42C. Per configuration settings previously established on server 14, window 40A directly connects to Internet content provider 16A, window 40B directly connects to Internet content provider 16B, window 40C directly connects to Internet content provider 16C, window 40D directly connects to Internet content provider 16D, and window 40E directly connects to Internet content provider 16E. In the example illustrated in FIG. 1, window 40E is smaller since window 40E is configured to be connected to non-video source such as an Internet radio source, obviating the need for a large display area. In the example illustrated in FIG. 1, window 40F is configured, per the customized settings entered from computer 18 to server 14, to be connected to an Internet source 18 (computer 18). In such an arrangement, files on the computer 18 may be streamed to window 40F. For example, photos or audio files, such as MP3 files or .WAV files, may be streamed via the local area network 32 to window 40F for display, or may play on speaker 40. As indicated in broken lines, window 40F may alternatively be connected to other local area network sources such as a person's home security system or an infant monitoring system, possibly including microphones and cameras in a person's home. Other examples include a person's Bluetooth communicating appliances such as a refrigerator or thermostat, or a person's distributed audio or stereo system with an appropriate Internet interface. An operator may identify such appliances to be controlled via touch screen 34. Because windows 40 are displayed as part of a touch screen, links or other graphical elements in the network-enabled content may be selected by a person touching the screen or the use of stylus 36. As a result, a person may jump to other links on a particular window 40 or make selections for controlling such things as the stereo, appliance, cameras and the like on the person's local area network. Internet purchases may also be made. In a preferred embodiment, voice over IP may be used to facilitate phone calls using appliance 12 or videoconferencing using camera 38. Different persons, such as different family members, may have different page settings for appliance 12 stored on server 14. For example, a mother may have a first layout of windows 40 and a first set of content to be displayed or provided on windows 40, while a teenage son may have a second layout of windows 40 and a second set of different content to be displayed in windows 40. Appliance 12 may easily toggle or switch between such pages by a person depressing or selecting a corresponding one of touch points 42.

According to one embodiment, a person may change content on a particular window 40 by touching the window 40 which causes server 14 to list other content providers from which the person may select. A person is also given the option of touching a part of touch screen 34 to change the number, size or positioning of windows 40 on display screen 34. All of such changes or options are stored at server 14 and simply transmitted to appliance 12. As a result, the complexity and cost of appliance 12 is kept to a minimum.

According to the embodiment shown, the appliance 12 also includes a connector for receiving an audio and video television signal, including a high-definition television signal 41, and a switch 43, by which a user can switch the display on the panel from the content described above to the television content.

FIG. 2 is an alternative view of the embodiment described above, in a more pictorial format. The following description lays out the invention in further detail.

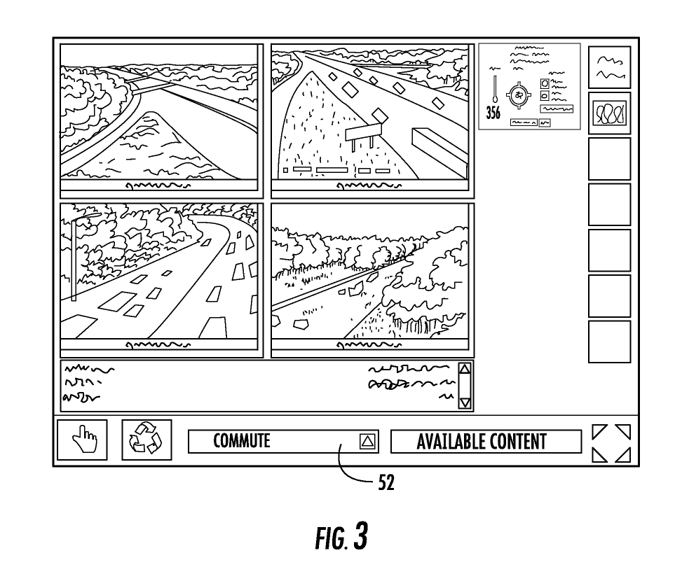

An example of the user interface is shown in FIG. 3. The “look and feel” of the present invention is unique. The methods provided by the invention for selecting a specific frame, designating content, selecting different pages (i.e. “Commute” in the example shown in FIG. 3), selecting “full screen mode”, and refreshing to the initial configuration and layout, are unique to the present invention.

The content available by use of this invention would be essentially limitless—based on current and future Internet technologies. Current examples are:
Web sites such as local weather, news (video or print), traffic information, etc.
Web applications such as shopping lists, recipe or diet minders, calendar functions (reminders, birthday planners), and personal phone directory including important phone numbers (doctor, veterinarian, and other emergency contacts);
Streaming Video from home surveillance, such as security or baby monitoring, including the ability to view remote locations (such as a vacation home);
Streaming Audio from either local radio stations or national providers;
Educational information from local schools such as weekly lunch menus, bus schedules, closings due to weather, recreational opportunities, and local announcements;
Government information such as fire and emergency numbers, public service announcements, voting locations, municipal information;
The above described video monitoring and/or interface can be combined with premise alarms and “panic” buttons for notifying authorities or monitoring services, resulting in a comprehensive home security interface;
Monitoring or control of environmental and lighting systems, telephony applications and video conferencing;
RSS feeds from various information sources.
   Importantly, since the content delivered would be controlled centrally, vertical solutions, such as information kiosks, would be practical. The advantage of centrally managing the units, either individually, or in groups, would be significant.

Within the scope of this document, “content” is specifically defined as the combination of a source URL and supporting source information (conduit) and user specific information required to enhance the delivery of the internet stream. For example, a conduit for WeatherBug™ would include the specific URL to a certain feature as well as the user information (such as zip code) which allows the WeatherBug™ URL to generate information appropriate to the specific geographic location of the device.

Conduits would be pre-configured by the service provider and the users would be able to select from these conduits and supply their specific required or optional information. The resulting data would represent “content” and would be targeted to a specific page frame on the appliance 12.

The appliance 12 is substantially a solid-state computer with an embedded version of Linux (or Windows, or similar) as the operating system. This “kernel” is customized to provide for the specific functionality needed without the overhead of unnecessary support. Upon startup the appliance 12 is configured to go to the server 14 or data center site to retrieve the interface configuration which would be presented to the user via an Internet browser (FireFOX™, or Windows™ or similar). The startup sequence would allow for firmware and browser patches and updates.

A single physical “home” button would refresh the display with the initial user page. A power button (which could be located away from the front surface, such as on the side) would allow for a cold-boot of the device.

Internet connectivity would be via wireless or physical hard-wired connection. The device would use any suitable system, preferably DHCP, to obtain a local IP address. An initial setup screen would be presented to the user upon first boot which would prompt the user for wireless configuration information if the appliance 12 is wireless, such as SSID and encryption key information such as a WEP key or WPA key. The appliance 12 could be reset to its initial state via a recessed “reset” switch (again, which could be located away from the front surface, such as on the back of the unit).

As to keyboard input, a major distinguishing factor of the present invention is that the appliance 12 is simple, inexpensive, and low maintenance. The invention does provide, however, for a software keyboard program which would be enabled under specific circumstances, to allow the user to enter character based input as appropriate.

In general, it would be appropriate to have dedicated “splashdown” pages for partners which would simplify user interaction. For example, an arrangement with an Internet book store could allow the user's personal (and even credit card) information to be passed when a dedicated “Shop for Books” button was pressed. The user would be relieved of significant data entry requirements.

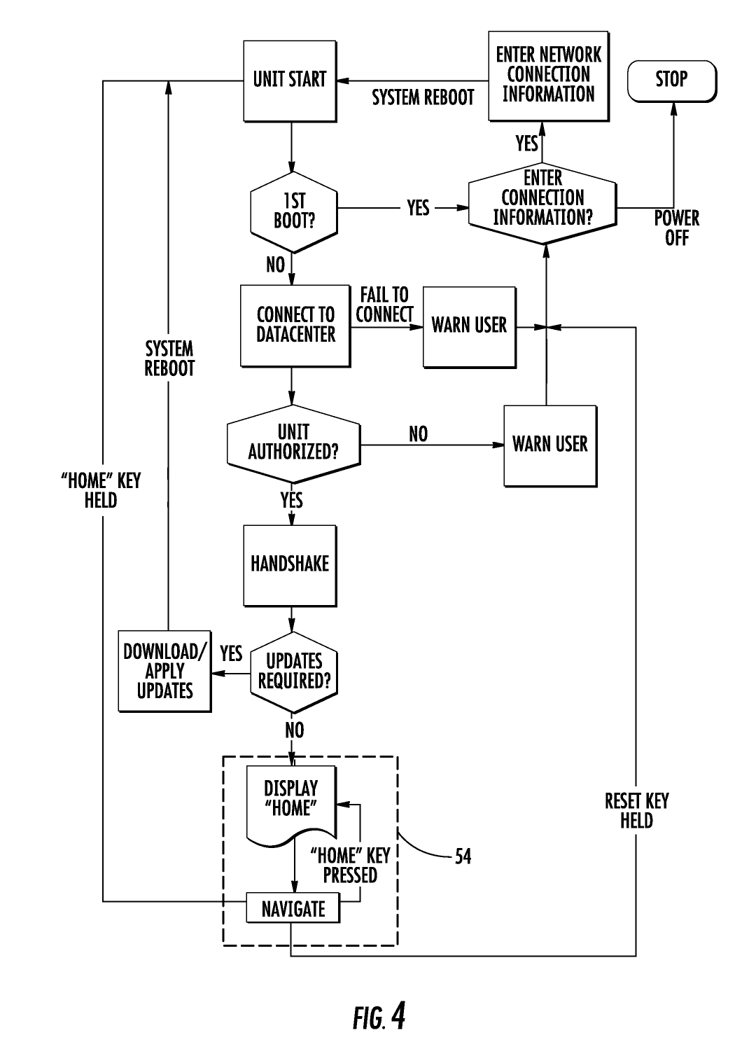

The system startup process is outlined in the diagram shown in FIG. 4. Once the “Handshake” is completed and no updates were required, the system would be directed to display the “Home” page via the browser display 54. This page would consist of a framework and SoftKeys which would be populated by information configured in the control panel. From this point on, the user would be able to navigate via the SoftKeys, an attached touch stylus, or via links on the touch screen of the content sites. At any point, the user can return to the “Home” page by pressing the physical “Home” key on the unit.

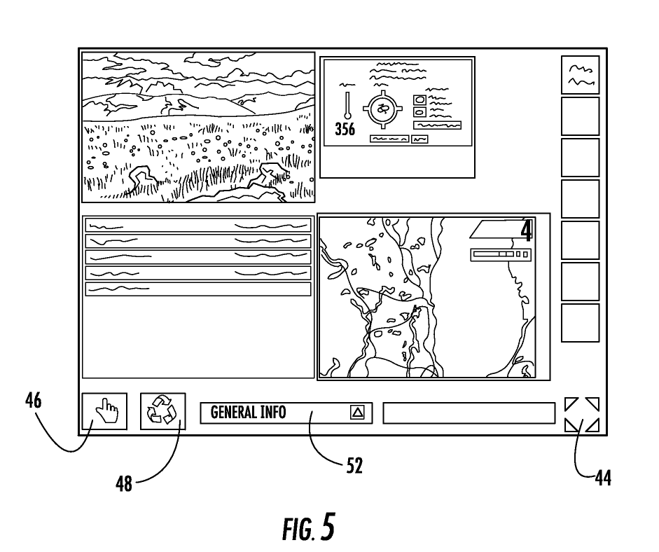

FIG. 5 shows a “standard 4-square” frameset with various content displayed in the frames. On the left, the top square is a clock. Additional squares can be loaded with “non-visual” content such as streaming audio. While it cannot be perceived in the drawing, the top left frame is cycling through a “slideshow” which consists of pictures that the user uploaded via the control panel. The top right frame is showing the local WeatherBug™ current conditions. The bottom right frame is showing the current weather radar from a local TV station. Lastly, the bottom left is showing a collection of RSS feeds of topics selected by the user. These feeds can each be selected and will expand showing current headlines. The user can select “full screen mode” 44 and navigate through the content.

Selection is performed via touching the screen. Pressing the “select button” 46 will allow the next touch of the screen to select a particular frame. Once the frame is selected, it is highlighted and it can either be made full-screen or the “Available Content” drop down can be used to target different content to the selected frame.

Pressing the “refresh” button 48 will restore the device to its default frameset configuration using the current content in each frame.

The control panel 50, shown in FIG. 2, is simply another web application which the users will access from any Internet connected workstation. This simple forms-based environment allows the user to configure content which is then available for display on the device.

As referenced above, content would be comprised of a pre-defined conduit and specific information to tailor that information to the device. Conduits would be defined by the service provider and subscribing users would be able to request (for a fee) that specific conduits be created. Advanced users could propose conduits (through a submission process) which would be added upon approval.

Each device will support multiple framesets, which could be referred to as pages. The user can select a particular frameset (layout) and then target content to each of the frames. The combination of the frameset and content selection can be saved as a page and named by the user.

When there is more than one page defined for a device, the “Page selection” drop down 52 (FIGS. 3 and 5) will become enabled. Pages can be optionally secured, which will require a password or bio-metric input to be validated in order to be selected. This security feature will guard against inadvertent or un-authorized purchases from “on-click” ecommerce sites.

Referring now to the infrastructure desirable for the invention, since the appliances 12 will not function without a connection to the server 14 or datacenter, the datacenter should exist in multiple locations with fully redundant databases. The technology for this currently exists as well as load balancing between datacenter locations.

Determining the scale of the infrastructure is simplified in that the number of devices is known. Though, at any time, some will not be activated, we know that the maximum number of devices accessing our servers is limited to the units produced.

Importantly, once startup is completed, the devices will function independently of the Datacenter (except for banner ads and the re-display of the “Home” page), so the bandwidth and capacity requirements will be significantly reduced.

A potential offering would be content filtering and parental control. If this option was selected, the appliance 12 would only consult “proxy” servers in the Datacenter, rather than go directly to specific web locations.

Security is substantially improved by this invention. Since the appliance 12 would be running a proprietary hardware/software combination, it would be immune from typical virus/malware attacks. The “read-only” nature of the “firmware” within the appliance 12 means that simply rebooting the unit would “re-install” the operating system image and programming. Each unit would be individually serialized and would only function after establishing a secure “handshake” with the Datacenter.

Communications with the Datacenter would be encrypted and if a unit were to be cloned, it would be possible to detect this activity by comparing the IP address or the MAC address of the unit to the account over time.

When a unit is purchased, there would be default configuration for each device which would allow for general functionality. It would be up to the user to access the “control panel” with a unit specific id and password, and enter the user's personal, location, and billing information. This action would register the device and allow the user to “customize” the unit for the user's location.

Although the present disclosure has been described with reference to example embodiments, changes may be made in form and detail without departing from the spirit and scope of the disclosed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present invention is described with reference to the example embodiments and set forth in the following claims.

1. An apparatus comprising:
a display;
a firmware associated with the display, the firmware including:
an operating system and a web browser, wherein the operating system and web browser are configured to automatically obtain configuration information from one or more remote data servers upon boot of the operating system, and based on that configuration information, connect to one or more internet servers using the web browser and automatically display content therefrom.

2. The apparatus of claim 1, wherein the configuration information comprises a frameset template obtained from the data server, the frameset including frames, wherein each frame includes a preset content locator.

3. The apparatus of claim 2 further comprising a data center server having preconfigured framesets with assigned content locators, wherein the data center server is configured to transmit one or more of the framesets to the web browser.

4. The apparatus of claim 1, wherein the operating system is configured to automatically display a frameset of a plurality of frames, each frame assigned a preset content locator addressing an internet server such that each frame has the ability to include content transmitted from a different internet server upon boot of the operating system.

5. The apparatus of claim 1 further comprising a touchscreen input.

6. The apparatus of claim 5, wherein the apparatus is self contained and configured to be mounted on a stand.

7. The apparatus of claim 5, wherein the apparatus is self contained and configured to be hung along a wall.

8. The apparatus of claim 5, wherein the apparatus is self contained and configured to be mounted under a cabinet.

9. The apparatus of claim 1, wherein the operating system and browser are configured solely to: (1) contact an data server and download a frameset template including automatically executed embedded internet links and (2) display the frameset and network-enabled content addressed by the links.

10. The apparatus of claim 1, wherein the browser is a firmware based or hard wired browser.

11. The apparatus of claim 1, further comprising;
a processor and associated memory capable of storing and running a web browser and an operating system, wherein the processor is configured to automatically connect to the data server and to automatically display content from one or more network-enabled servers upon boot of the operating system.

12. The device of claim 11, wherein the device is dedicated for and configured solely to display network-enabled content.

13. A method comprising:
contacting a data server with an operating system automatically upon boot to obtain configuration information;
receiving the configuration information, including a frameset, from the data server, the frameset including a plurality of frames, each frame having a preassigned address of a network-enabled content provider;
receiving content for each frame from the network-enabled content providers; and
displaying the frameset and content of each frame.

14. An apparatus comprising:
a display;
a firmware associated with the display and configured to automatically connect to one or more internet servers and to automatically display content from the one or more servers upon boot of the firmware.

15. The apparatus of claim 14, wherein the firmware consists solely of a web browser and an operating system.
